(19) United States
(12) Patent Application Publication
(10) Pub. No.: US 2009/0133561 A1
(43) Pub. Date: May 28, 2009

(54) THIN SECTION PREPARING APPARATUS AND THIN SECTION PREPARING METHOD

(76) Inventors: Tetsumasa Ito, Chiba-shi (JP); Koji Fujimoto, Chiba-shi (JP)

Correspondence Address: BRINKS HOFER GILSON & LIONE, P.O. BOX 10395, CHICAGO, IL, 60610, US

(21) Appl. No.: 12/275,588

(22) Filed: Nov. 21, 2008

(30) Foreign Application Priority Data
Nov. 27, 2007 (JP) JP2007-306354

(51) Int. Cl. B26D 5/20; B26D 5/00; B26D 1/00

(52) U.S. Cl. 83/734; 83/76.1; 83/13

(57) ABSTRACT

An apparatus that slices an embedded block having a biological sample embedded therein to prepare a thin section, includes: a cutter that slices the embedded block; a moving mechanism that relatively moves the block and the cutter along an approaching and separating direction in which they approach and separate from each other; a height adjusting mechanism that relatively moves them along a vertical direction; a sliding mechanism that relatively moves them along a sliding direction nearly orthogonal to the approaching and separating direction; and a control unit that controls them to begin to move at initial positions set in advance, the block to be brought into contact at the same point of a nose of the cutter, and the cutter to be slid in the same direction as a ratio between a velocity in the approaching and separating direction and a velocity in the sliding direction is kept the same.

### RELATED APPLICATIONS

This application claims priority under 35 U.S.C. §119 to Japanese Patent Application No. JP2007-306354 filed on Nov. 27, 2007, the entire content of which is hereby incorporated by reference.

### BACKGROUND OF THE INVENTION

1. Field of the Invention

The present invention relates to a thin section preparing apparatus and a thin section preparing method, in which an embedded block having a biological sample embedded therein is sliced to prepare a thin section as a step before a thin section sample is prepared for use in physicochemical experiment or microscopic observation.

2. Description of the Related Art

Heretofore, as one method of examining a biological sample taken out of a human body or a laboratory animal, such a method is known that a biological sample is sliced in an ultrathin section and applied to various stains, and then examined by microscopic observation. This examination method is mainly known as a technique that is adopted in conducting a toxicological examination or a histopathological examination, which is one of examinations prior to clinical trials in new drug development.

Generally, in conducting this examination, in order to slice a biological sample so as not to damage the form of soft tissue or cells, first, the biological sample is embedded in an embedding material such as paraffin in advance to form an embedded block. Then, this embedded block is sliced to have a thickness of about 2 to 5 micrometers, whereby a thin section is prepared. In this manner, even though an examination subject is soft tissue, the examination subject can be sliced in an ultrathin section without damaging the form.

In addition, this thin section is fixed on a substrate such as a slide glass to prepare a thin section sample. Generally, an operator observes the thin section sample under a microscope to conduct various examinations.

In order to prepare the thin section, two process steps, a rough sectioning operation and a fine sectioning operation, are conducted to slice off a thin section from an embedded block. The rough sectioning operation is the process step in which an embedded block is gradually sliced to make the front surface thereof a smooth surface and a biological sample embedded in the embedded block is exposed in the front surface. After that, by conducting the fine sectioning operation, the embedded block in which the sample is exposed in the front surface is sliced to prepare a thin section. In conducting the rough sectioning operation and the fine sectioning operation, it is necessary to slice the embedded block by a cutter many times until a desired smooth surface or thin section is obtained. Thus, the sharpness of the cutter is gradually degraded. Particularly, because an embedding material such as paraffin is attached to the cutter, the sharpness tends to be degraded.

Such an apparatus is known that the sharpness of a cutter can be maintained excellently for a long time (see Japanese Patent No. 3,604,593). FIG. 7 shows a top view depicting the apparatus slicing off a thin section from an embedded block. As shown in FIG. 7, this apparatus is configured in which in moving an embedded block 102 along an L-axis so as to approach the cutter 101, the cutter 101 can be moved along an M-axis that is orthogonal to the L-axis and in parallel with a nose of the cutter 101. When this configuration is adopted, the effect of a declination angle manually implemented can be reproduced, and thus the sharpness of the cutter 101 can be improved as well as the sharpness can be maintained for a long time.

However, in the apparatus before, the following problems still remain.

First, it is necessary to change the cutter that slices the embedded block at predetermined frequencies in order to secure certain sharpness. On this occasion, the cutter is set in such a way that the nose is in parallel with the front surface of the embedded block. However, it is difficult to set the cutter in this way every time. On this account, as shown in FIGS. 8A and 8B, in the thin section preparing apparatus before, the cutter 101 is often set as the nose is inclined. In addition, FIGS. 8A and 8B show diagrams depicting the apparatus before in slicing the embedded block 102 to prepare a thin section. FIG. 8A shows a top view, and FIG. 8B shows a side view. In addition, FIG. 8B depicts the cutter 101 in which the nose is inclined by a chain double-dashed line.

Here, in order to move the cutter 101 in the direction in parallel with the nose, it is necessary that the slope of the nose is detected and the cutter 101 is moved along the detected slope. Thus, in the apparatus before, it is difficult to control the cutter 101 to move, which leads to a complicated configuration and cost increases.

In addition, in the apparatus before, there is also a problem that a thin section of desired quality cannot be prepared. In other words, in order to obtain a thin section having a thickness of 2 to 3 micrometers, it is necessary that the wobbling of the nose of the cutter 101 is maintained within 0.5 micrometers in the normal direction of the surface on which the cutter 101 travels.

Here, typically in the cutter 101, the nose is not straight, and there is waviness more or less. On this account, although it is necessary that the cutter 101 is fine-adjusted and set within the tolerance in consideration of this waviness, such fine adjustment is very difficult. Therefore, the prepared thin section is continuously varied in thickness, and it is difficult to obtain a thin section of desired quality. In addition, even though such a thin section is stained, dyeing speck occurs to make an inferior thin section sample, which as well causes an inaccurate examination to adversely affect examination results.

### SUMMARY OF THE INVENTION

The invention has been made in the light of circumstances. An object is to provide a thin section preparing apparatus and a thin section preparing method which can prepare a thin section of high quality with no influence of the slope or waviness of a nose as improved sharpness is secured for a long time while the configuration can be simplified and costs can be reduced.

In order to solve the problems, the invention proposes the following schemes.

The invention is a thin section preparing apparatus that slices an embedded block having a biological sample embedded therein to prepare a thin section, the apparatus including: a cutter that slices the embedded block; a moving mechanism that relatively moves the embedded block and the cutter along an approaching and separating direction in parallel with an assumed plane, in the direction in which the embedded block and the cutter approach and separate from each other, and slices off the thin section from the embedded block by the cutter; a height adjusting mechanism that relatively moves the embedded block and the cutter along a vertical direction vertical to the assumed plane and adjusts a height of the embedded block; a sliding mechanism that relatively moves the embedded block and the cutter along a sliding direction in parallel with the assumed plane and nearly orthogonal to the approaching and separating direction, and relatively slides the embedded block and the cutter in slicing off the thin section; and a control unit that controls operations of the moving mechanism and the sliding mechanism in slicing off the thin section in such a way that the embedded block and the cutter begin to move from an initial position set in advance, the embedded block is brought into contact at a same point of a nose of the cutter, and then the cutter is slid in the same direction as a ratio between a velocity in the approaching and separating direction and a velocity in the sliding direction is kept the same.

In addition, the invention is a thin section preparing method of slicing an embedded block having a biological sample embedded therein by a cutter to prepare a thin section, the method including the steps of: setting wherein positions of the embedded block and the cutter are individually moved to initial positions set in advance; adjusting height wherein the embedded block and the cutter are relatively moved along a vertical direction vertical to an assumed plane to adjust a height of the embedded block set at the initial position to be a predetermined height; and cutting wherein after the height adjusting step, the embedded block and the cutter are relatively moved along two directions, an approaching and separating direction in parallel with the assumed plane, in the direction in which the embedded block and the cutter approach and separate from each other, and a sliding direction in parallel with the assumed plane and nearly orthogonal to the approaching and separating direction, and the embedded block is sliced to cut off the thin section while the embedded block and the cutter are being relatively slid, wherein motions of the cutter and the embedded block are controlled from the initial positions in such a way that in conducting the cutting step, the embedded block is brought into contact at a same point of a nose of the cutter, and then the cutter is slid in the same direction as a ratio between a velocity in the approaching and separating direction and a velocity in the sliding direction is kept the same.

In accordance with the thin section preparing apparatus and the thin section preparing method according to the invention, as the setting step, the positions of the embedded block and the cutter are individually moved to the initial positions set in advance. Subsequently, as the height adjusting step, the height adjusting mechanism relatively moves the embedded block and the cutter along the vertical direction vertical to the assumed plane, and adjusts the height of the embedded block set at the initial position to be a predetermined height. Subsequently, the cutting step is conducted in which the embedded block is sliced to cut off the thin section. In other words, the moving mechanism relatively moves the embedded block and the cutter along the approaching and separating direction in such a way that they approach each other, and the sliding mechanism relatively moves the embedded block and the cutter along the sliding direction nearly orthogonal to the approaching and separating direction. Thus, the embedded block is sliced to prepare a thin section while the embedded block and the cutter are being relatively slid. Particularly, because the embedded block and the cutter are relatively slid in slicing the embedded block, the resultant force of two directions (the approaching and separating direction and the sliding direction) nearly orthogonal to each other acts on the thin section to be sliced off. Therefore, the embedded block can be sliced with the same effect as the effect that a declination angle is provided to the cutter. Accordingly, the sharpness of the cutter is improved as well as the sharpness can be secured for a long time.

In addition, the sliding direction in relatively sliding the embedded block and the cutter is simply set in the direction nearly orthogonal to the approaching and separating direction, regardless of the slope of the nose of the cutter. Therefore, even though the cutter is attached with inclination, such complicated control before is eliminated that the slope of the nose of the cutter is detected and the cutter is moved along the detected slope. Accordingly, the configuration can be simplified, and costs can be reduced.

Moreover, the control unit controls the motions of the cutter and the embedded block from the initial positions in such a way that the embedded block is brought into contact at the same point of the nose of the cutter in conducting the cutting step, and then the cutter is slid in the same direction as the ratio between the velocity in the approaching and separating direction and the velocity in the sliding direction is kept the same. Thus, even though many thin sections are sliced off from the embedded block, only the same area of the nose of the cutter can be continuously used. In other words, it can be prevented that the embedded block is sometimes sliced on the base end side of the nose or sometimes on the tip end side of the nose, and the embedded block can be sliced in a determined area every time. Therefore, even though the nose of the cutter has waviness, the front surface of the embedded block is in the form following the waviness of the cutter, and thin sections can be sliced off in a uniform thickness. Accordingly, a thin section of high quality can be prepared with no occurrence of dyeing speck even stained.

In addition, in the thin section preparing apparatus according to the invention, preferably, in relatively moving the embedded block and the cutter along the approaching and separating direction and the sliding direction, the control unit individually controls the moving mechanism and the sliding mechanism in such a way that a rate of travel at least in any one of the moving directions becomes a constant speed.

In addition, in the thin section preparing method according to the invention, preferably, in relatively moving the embedded block and the cutter along the approaching and separating direction and the sliding direction in the cutting step, control is conducted in such a way that a rate of travel at least in any one of the moving directions becomes a constant speed.

In accordance with the thin section preparing apparatus and the thin section preparing method according to the invention, in relatively moving the embedded block and the cutter along the approaching and separating direction and the sliding direction in the cutting step, the control unit controls the operations of the moving mechanism and the sliding mechanism in such a way that a rate of travel at least in any one of the moving directions becomes a constant speed. Thus, it is sufficient that the operations of the moving mechanism and the sliding mechanism are controlled so as to simply repeat a certain operation in relation to at least in any one of the moving directions. In other words, such complicated control before is eliminated that the speed is varied. Accordingly, control conducted by the control unit in the cutting step can be made easier, and the configuration can be more simplified.

In addition, in the thin section preparing apparatus according to the invention, preferably, in relatively moving the embedded block and the cutter along the approaching and separating direction and the sliding direction, the control unit individually controls the moving mechanism and the sliding mechanism in such a way that a rate of travel in each of the directions becomes a constant speed.

In addition, in the thin section preparing method according to the invention, preferably, in relatively moving the embedded block and the cutter along the approaching and separating direction and the sliding direction in the cutting step, control is conducted in such a way that a rate of travel in each of the directions becomes a constant speed.

In accordance with the thin section preparing apparatus and the thin section preparing method according to the invention, in relatively moving the embedded block and the cutter along the approaching and separating direction and the sliding direction in the cutting step, the control unit controls the operations of the moving mechanism and the sliding mechanism in such a way that the rate of travel in each of the directions becomes a constant speed. Thus, even in any directions, it is sufficient that the operations of the moving mechanism and the sliding mechanism are controlled so as to simply repeat a certain operation. Accordingly, control conducted by the control unit in the cutting step can be made easier, and the configuration can be more simplified.

Particularly, because the rates of travel in the two directions (the approaching and separating direction and the sliding direction) are at a constant speed all the time, the same resultant force continuously acts on the thin section to be sliced off. Thus, the similar effect can be obtained as the effect that the embedded block is sliced as the same declination angle is provided all the time. Consequently, stable slicing can be conducted, and a thin section of high quality can be prepared with no wrinkles.

In addition, in the thin section preparing apparatus according to the invention, preferably, the moving mechanism has an approach guide rail that extends along the approaching and separating direction, and an approach stage that is movable along the approach guide rail as the embedded block is held, the height adjusting mechanism has an ascending and descending guide rail that is extended along the vertical direction, and an ascending and descending stage that is movable along the ascending and descending guide rail as the embedded block is held, and the sliding mechanism has a cutter holder that holds the cutter, and a slider unit that moves the cutter holder along the sliding direction.

In addition, in the thin section preparing method according to the invention, preferably, in conducting the height adjusting step, the embedded block is moved along the vertical direction, and in conducting the cutting step, the embedded block is moved along the approaching and separating direction and the cutter is moved along the sliding direction.

In accordance with the thin section preparing apparatus and the thin section preparing method according to the invention, both of the embedded block and the cutter are not moved, the ascending and descending stage holding the embedded block is simply moved along the ascending and descending guide rail, whereby the cutter and the embedded block can be relatively moved along the vertical direction. In addition, the approach stage holding the embedded block is simply moved along the approach guide rail, whereby the cutter and the embedded block can be relatively moved along the approaching and separating direction. Similarly, both of the embedded block and the cutter are not moved, the cutter holder holding the cutter is simply moved by the slider unit, whereby the cutter and the embedded block can be relatively moved in the sliding direction. In other words, in conducting the height adjusting step, the ascending and descending stage is simply moved along the ascending and descending guide rail, whereby the embedded block and the cutter can be relatively moved along the vertical direction. In addition, in conducting the cutting step, the approach stage is simply moved along the approach guide rail and the cutter holder is moved along the sliding direction by the slider unit, whereby the embedded block and the cutter can be relatively moved along the approaching and separating direction and the sliding direction individually. Accordingly, such a complicated motion is eliminated that the embedded block or the cutter is moved in a different direction, and such a simple motion is enough that the embedded block or the cutter is simply moved in one direction. Accordingly, the motions of the moving mechanism and the sliding mechanism can be made easier, and the configuration can be more simplified.

In addition, in the thin section preparing method according to the invention, preferably, the cutting step is conducted under a same velocity ratio condition by a rough sectioning operation in which the embedded block is roughly sectioned, and by a fine sectioning operation in which the embedded block after roughly sectioned is finely sliced.

In accordance with the thin section preparing method according to the invention, in the cutting step, the rough sectioning operation and the fine sectioning operation are conducted under the same velocity ratio condition, and thus the rough sectioning and fine sectioning operations can be conducted under the same slicing condition. Accordingly, a thin section of higher quality can be prepared.

In accordance with the thin section preparing apparatus and the thin section preparing method according to the invention, a thin section of high quality can be prepared with no influence of the slope or waviness of a nose as improved sharpness is secured for a long time while the configuration can be simplified and costs can be reduced.

### BRIEF DESCRIPTION OF THE DRAWINGS

The teachings of the invention can be readily understood by considering the following detailed description in conjunction with the accompanying drawings, in which:

FIG. 1 shows a top view depicting a thin section preparing apparatus according to an embodiment of the invention;

FIG. 2 shows a side view depicting the thin section preparing apparatus according to an embodiment of the invention;

FIG. 3 shows a flowchart depicting a thin section preparing method according to an embodiment of the invention;

FIG. 4 shows a side view depicting the thin section preparing apparatus according to an embodiment of the invention in conducting a cutting step;

FIG. 5 shows diagrams depicting a sequence of a flow in the case in which an embedded block is sliced to prepare a thin section in the thin section preparing apparatus according to an embodiment of the invention;

FIG. 6 shows a top view depicting a modification of a thin section preparing apparatus according to an embodiment of the invention;

FIG. 7 shows a diagram depicting a sequence of a flow in the case in which an embedded block is sliced to prepare a thin section in a thin section preparing apparatus before; and

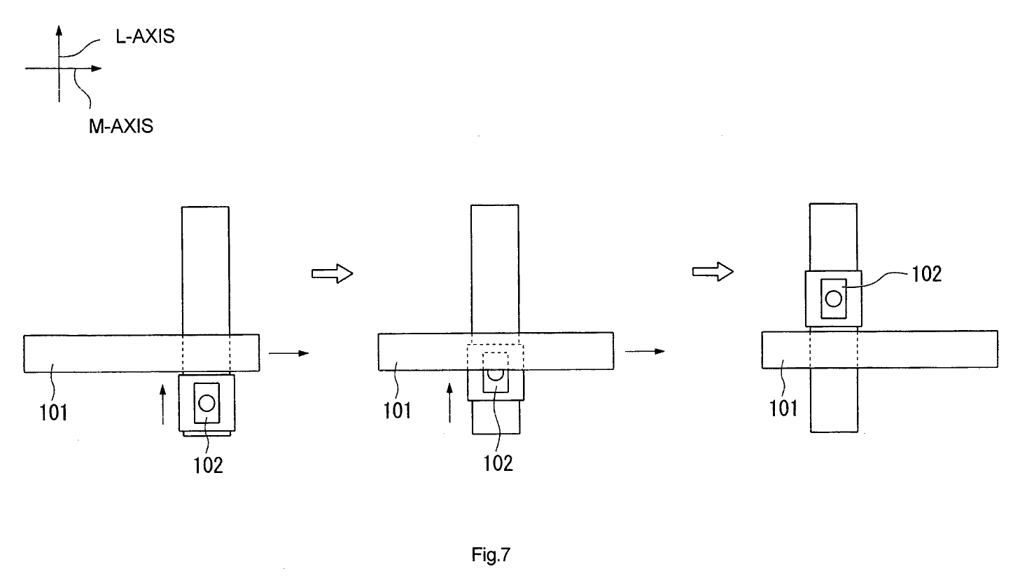

FIGS. 8A and 8B show diagrams depicting a thin section preparing apparatus before, FIG. 8A shows a top view, and FIG. 8B shows a side view.

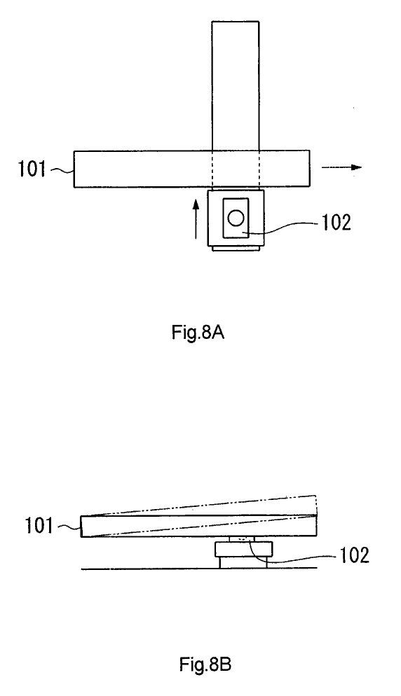

### DETAILED DESCRIPTION OF THE INVENTION

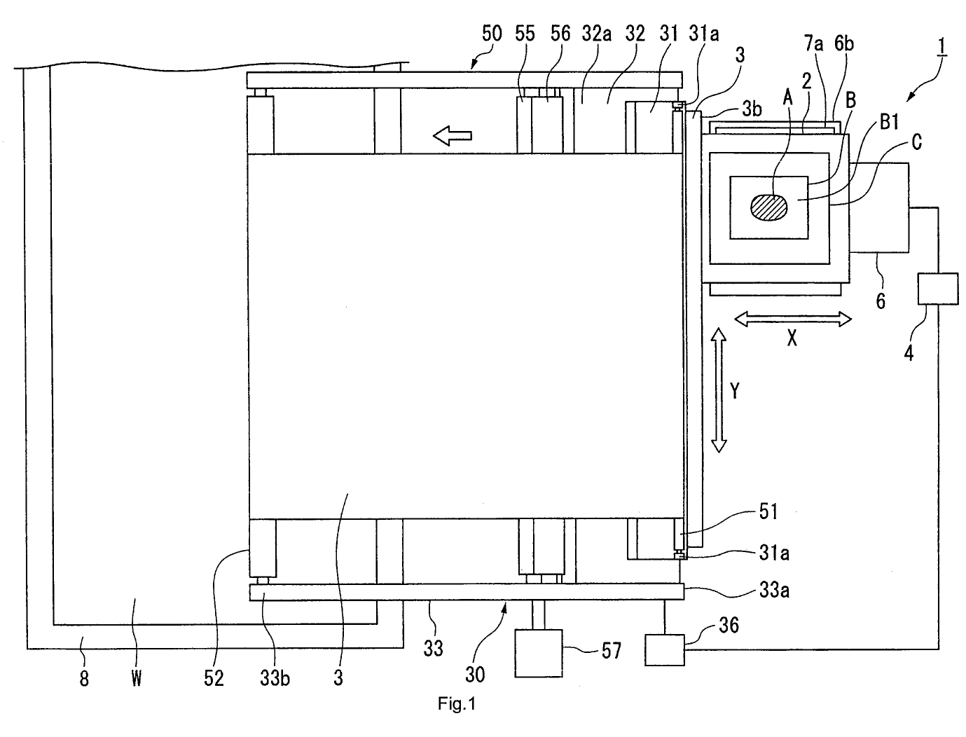

Hereinafter, an embodiment of the invention will be described with reference to FIGS. 1 to 5.

As shown in FIG. 1, a thin section preparing apparatus 1 according to the embodiment is an apparatus that slices an embedded block B having a biological sample A embedded therein in an ultrathin section having a thickness of about 3 to 5 micrometers to prepare a thin section S and carries the prepared thin section S to a subsequent process step. In addition, this thin section preparing apparatus 1 is mainly used in the process of examining and observing the biological sample A included in the thin section S.

For example, the biological sample A is tissue such as an organ taken out of a human body or a laboratory animal, which is freely selected in the fields of medical cares, drugs, foods, and biology. In addition, the embedded block B is a block that the biological sample A is embedded in an embedding agent B1, that is, the biological sample A is covered and solidified with the embedding agent B1. More specifically, such an embedded block B is prepared as the following manner. First, a block of the biological sample A is immersed in formalin to solidify protein configuring the biological sample A. Then, tissue is formed into a solid state, and then cut into blocks in proper size. Lastly, the moisture inside the cut biological sample A is replaced with the embedding agent B1, and then the cut biological sample A is placed in the dissolved embedding agent B1 for solidification to prepare an embedded block B. Here, the embedding agent B1 is a material that is easily liquefied, cooled and solidified and is immersed in ethanol for dissolution, which is a resin or paraffin, for example. Hereinafter, the configuration of the thin section preparing apparatus 1 will be described.

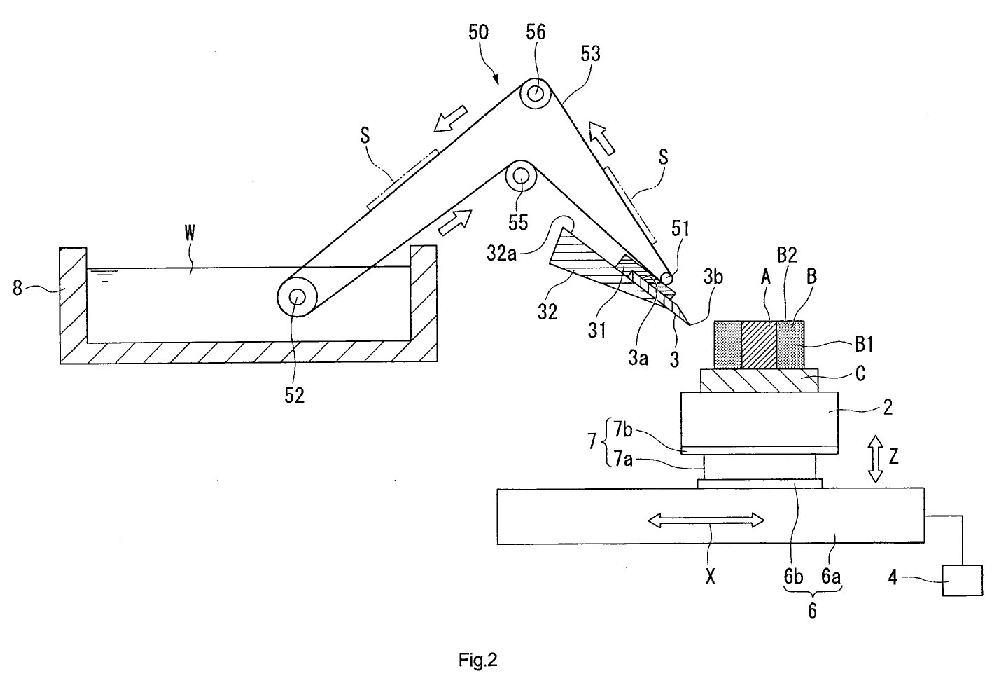

As shown in FIGS. 1 and 2, the thin section preparing apparatus 1 has a sample stage 2 that fixes a cassette C on which the embedded block B is placed thereon, a sliding mechanism 30 that slides a cutter 3 for slicing the embedded block B along a sliding direction Y, a control unit 4 that controls the operations of an X-stage 6 and the sliding mechanism 30, described later, and a carrying unit 50 that carries a thin section S sliced off from the embedded block B by the cutter 3.

The sample stage 2 is configured to position and fix the cassette C on which the embedded block B is placed. In addition, below the sample stage 2, the X-stage 6 and a Z-stage 7 are arranged so as to overlap with each other.

The X-stage 6 functions as a moving mechanism that relatively moves the embedded block B and the cutter 3 along an approaching and separating direction X in parallel with a horizontal plane (assumed plane), in the direction in which the embedded block B and the cutter 3 approach and separate from each other, and slices off a thin section S from the embedded block B by the cutter 3. In other words, the X-stage 6 is configured of an approach guide rail 6a that is extended along the approaching and separating direction X, and an approach stage 6b that is movable along the approach guide rail 6a as the approach stage 6b supports the sample stage 2 thereon, the sample stage 2 holding the embedded block B through the Z-stage 7. In other words, in the embodiment, both of the embedded block B and the cutter 3 are not moved, the approach stage 6b that supports the sample stage 2 holding the embedded block B is simply moved along the approach guide rail 6a, whereby the cutter 3 and the embedded block B can be relatively moved along the approaching and separating direction X. In addition, the operation of the X-stage 6 is controlled by the control unit 4. This operation will be described later.

The Z-stage 7 functions as a height adjusting mechanism that relatively moves the embedded block B and the cutter 3 along a vertical direction Z vertical to the horizontal plane and adjusts the height of the embedded block B. In other words, the Z-stage 7 is configured of an ascending and descending guide rail 7a that is extended along the vertical direction Z, and an ascending and descending stage 7b that is movable along the ascending and descending guide rail 7a as the ascending and descending stage 7b holds the embedded block B through the sample stage 2. In other words, in the embodiment, both of the embedded block B and the cutter 3 are not moved, the ascending and descending stage 7b that supports the sample stage 2 holding the embedded block B is simply moved along the ascending and descending guide rail 7a, whereby the cutter 3 and the embedded block B can be relatively moved along the vertical direction Z. In addition, the Z-stage 7 is fixed on the approach stage 6b, and moved along the approaching and separating direction X in association with the move of the approach stage 6b.

Then, the operation of the Z-stage 7 is controlled by the control unit 4, as similar to the X-stage 6. More specifically, the Z-stage 7 is controlled so as to ascend the embedded block B by a predetermined amount as matched with the slide motion of the approach stage 6b. Thus, the embedded block B is cut in a predetermined thickness to slice off the thin section S.

The sliding mechanism 30 is a mechanism relatively moves the embedded block B and the cutter 3 along the sliding direction Y in parallel with the horizontal plane and nearly orthogonal to the approaching and separating direction X and relatively slides the embedded block B and the cutter 3 in slicing off the thin section S. In other words, the sliding mechanism 30 has a holder (cutter holder) 31 that holds the cutter 3 between a platform 32 and the holder 31, and a slider unit 36 that moves the holder 31 holding the cutter 3 along the sliding direction Y through a frame 33.

The cutter 3 is arranged above the approach guide rail 6a as a nose 3b faces the embedded block B fixed on the sample stage 2. Particularly, the cutter 3 has the nose 3b long enough in the sliding direction Y so that the cutter 3 can slice the embedded block B while the cutter 3 is being slid in the sliding direction Y by the slider unit 36.

The holder 31 is arranged as a part thereof is abutted against a top surface 32a of the platform 32 supporting the cutter 3, which clamps the cutter 3 between the platform 32 and the holder 31. Thus, the cutter 3 is held as the nose 3b is exposed with no wobbles. In addition, the holder 31 is configured that it can be removed from the platform 32, and the cutter 3 can be changed.

The platform 32 is arranged along the sliding direction Y so as to support the cutter 3 and the holder 31 on the top surface 32a, and the both ends thereof are fixed to the frame 33.

The frame 33 is frames arranged in parallel with each other as they sandwich the cutter 3 and the platform 32 therebetween, and extended along the approaching and separating direction X. In addition, in FIG. 2, the frame 33 is omitted in the drawing. The both ends of the platform 32 are fixed to front end portions 33a of the frame 33. Thus, the cutter 3, the holder 31, the platform 32, and the frame 33 are configured in one piece. In addition, to the frame 33, a rear roller 52 and intermediate rollers 55 and 56, described later, are pivotally attached.

The frame 33 is configured to be movable by the slider unit 36 along the sliding direction. For example, for the slider unit 36, such a mechanism can be named in which a cabinet, not shown, that supports the frame 33 and a stage, not shown, that supports the cabinet are provided and the stage is moved by a servomotor. Therefore, the slider unit 36 is operated to move the cutter in the sliding direction Y together with the frame.

In other words, in the embodiment, both of the embedded block B and the cutter 3 are not moved, the holder 31 holding the cutter 3 is simply moved by the slider unit 36 through the platform 32 and the frame 33, whereby the cutter 3 and the embedded block B can be relatively moved along the sliding direction Y. In addition, the operation of the slider unit 36 is controlled by the control unit 4, as similar to the X-stage 6. This operation will be described later.

Rear end portions 33b of the frame 33 are immersed in a fluid W stored in a liquid bath 8. In addition, for example, for the fluid W, water, hot water or a specific solution is named. The liquid bath 8 is designed long enough in the sliding direction Y.

The control unit 4 controls the operations of the X-stage 6 and the sliding mechanism 30 in such a way that the embedded block B and the cutter 3 begin to move at initial positions set in advance in slicing off the thin section S. More specifically, the control unit 4 conducts control in such a way that the embedded block B is brought into contact at the same point of the nose 3b of the cutter 3, and then the cutter 3 is slid in the same direction. Here, the initial position is the absolute position in each of the approaching and separating direction X and the sliding direction Y, which is determined in relation to the embedded block B and to the cutter 3 by reading a memory, by computation, or by detecting marks by the control unit 4. In addition, the control unit 4 according to the embodiment is configured to individually control the X-stage 6 and the slider unit 36 in such a way that the rates of travel become a constant speed along the approaching and separating direction X and the sliding direction Y in relatively moving the embedded block B and the cutter 3 in these directions. Moreover the control unit 4 is configured to control the velocity ratio to be the same in the two directions (the approaching and separating direction X and the sliding direction Y) regardless of the rough sectioning operation or the fine sectioning operation.

The carrying unit 50 has a front roller 51 that is arranged close to the nose 3b, a rear roller 52 that is arranged on the rear side of the cutter 3, and an endless belt 53 that is wounded between the front roller 51 and the rear roller 52. The front roller 51 and the rear roller 52 are arranged almost in parallel with the sliding direction Y. In these two rollers, the front roller 51 is pivotally attached to a pair of support members 31a arranged as projected above from the top surface of the holder 31. On this occasion, the front roller 51 is pivotally attached to the support members 31a as a clearance is spaced to pass the endless belt 53 between the front roller 51 and the holder 31 of the cutter 3. On the other hand, the rear roller 52 is pivotally attached to the rear end portions 33b of the frame 33 as immersed in the fluid W in the liquid bath 8 together with the frame 33. Furthermore, between the front roller 51 and the rear roller 52, the two intermediate rollers 55 and 56 are pivotally attached to the frame 33, the intermediate rollers 55 and 56 being located above more than the front roller 51 and the rear roller 52. These two intermediate rollers 55 and 56 are arranged almost in parallel with the sliding direction Y between the front roller 51 and the rear roller 52. In addition, to the intermediate roller 56, one of these rollers, a motor 57 is connected. Thus, as shown in FIG. 1, the motor 57 is driven to endlessly run the endless belt 53 of the carrying unit 50 almost in parallel with the approaching and separating direction X seen in plane.

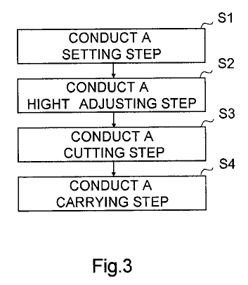

Next, a method of preparing a thin section S using the thin section preparing apparatus 1 according to the embodiment will be described. FIG. 3 shows a flowchart depicting a method of preparing a thin section S according to the invention.

First, the cassette C on which the embedded block B is placed is set on the sample stage 2 in a predetermined orientation. Subsequently, as the step before slicing is conducted, a setting step S1 is conducted. In other words, the control unit 4 activates the operations of the approach stage 6b of the X-stage 6 and the slider unit 36 of the sliding mechanism 30, whereby the positions of the embedded block B and the cutter 3 are moved to the initial positions set in advance. Since the initial position is the absolute position in each of the approaching and separating direction X and the sliding direction Y determined by the control unit 4 in relation to the embedded block B and to the cutter 3, in conducting the setting step S1, the positions of the embedded block B and the cutter 3 are moved to the same positions every time.

After the setting step S1 is finished, a height adjusting step S2 is conducted. In other words, the height of the embedded block B set at the initial position is adjusted by the Z-stage 7 through the sample stage 2. In other words, the ascending and descending stage 7b is moved along the ascending and descending guide rail 7a in such a way that the embedded block B and the cutter 3 approach each other. For example, preferably, the height to be adjusted is the height at which the embedded block B can be sliced by the cutter 3 in a predetermined thickness (about 3 to 5 micrometers).

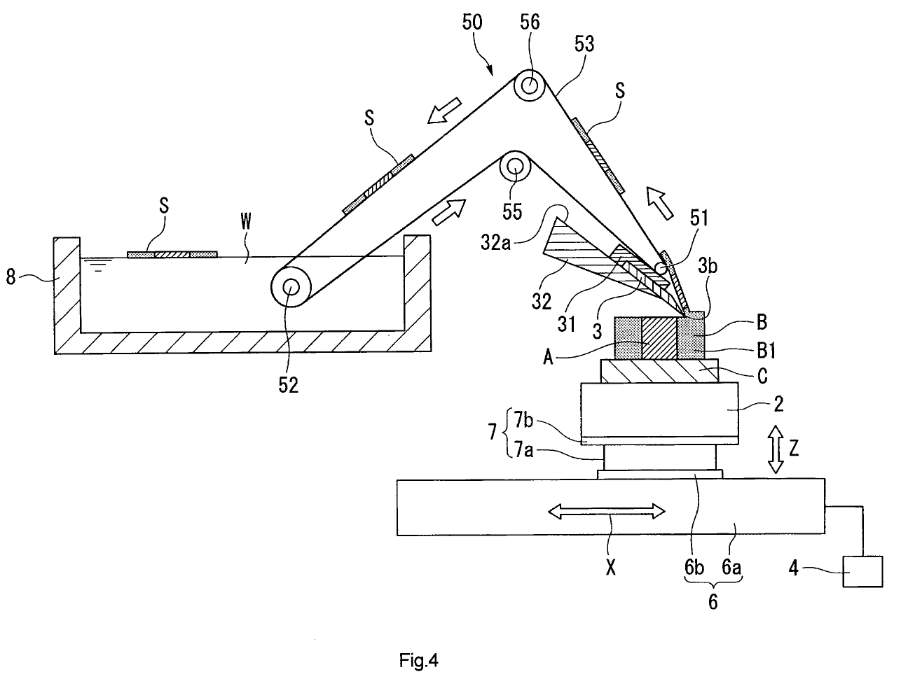

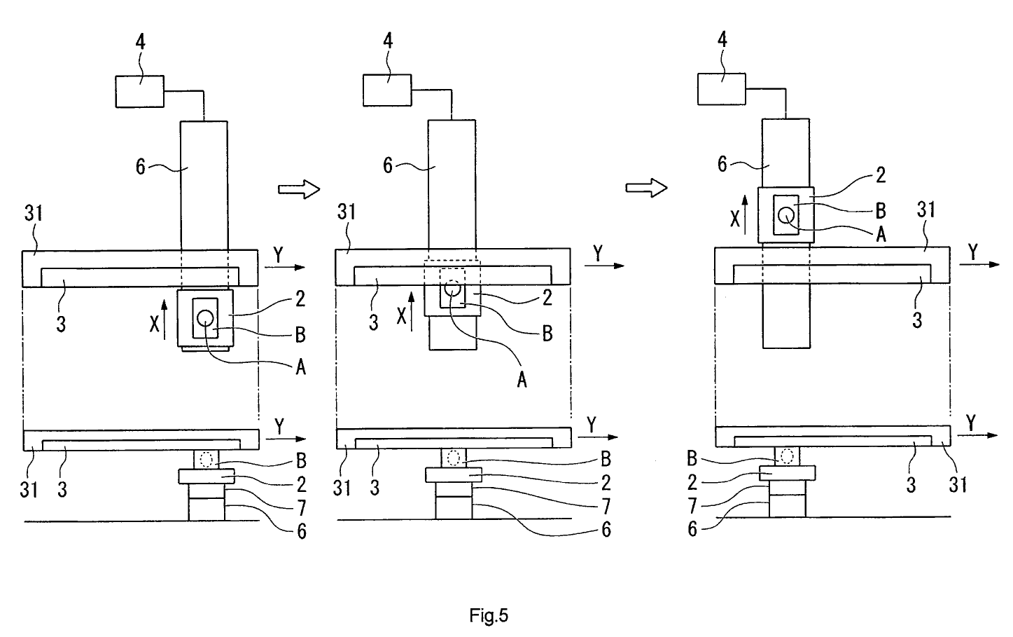

After the height adjusting step S2 is finished, a cutting step S3 in which the embedded block B is sliced to cut off a thin section S and a carrying step S4 in which the sliced thin section is carried to the liquid bath W are continuously conducted. In other words, as shown in FIGS. 4 and 5, the approach stage 6b is moved along the approach guide rail 6a in such a way that the embedded block B and the cutter 3 approach each other, and the frame 33 is moved by the slider unit 36 along the sliding direction Y. Thus, the embedded block B can be sliced to prepare a thin section S while the embedded block B and the cutter 3 are being relatively slid. Particularly, because the embedded block B and the cutter 3 are relatively slid in slicing the embedded block B, the resultant force of the two directions (the approaching and separating direction X and the sliding direction Y) nearly orthogonal to each other acts on the thin section to be sliced off. Thus, the embedded block B can be sliced with the same effect as the effect that a declination angle is provided to the cutter 3. Therefore, the sharpness of the cutter 3 is improved as well as the sharpness can be secured for a long time.

On the other hand, the control unit 4 drives the motor 57 to run the endless belt 53 at the same time at which the approach stage 6b is operated. Thus, the thin section S that is being gradually sliced off by the cutter 3 is turned above the cutter 3, passed over the front roller 51, and begins to be placed onto the endless belt 53. Then, the thin section S is fully sliced off from the embedded block B, carried on the rear side of the cutter 3 as the thin section S is placed on the endless belt 53, and then advanced toward the rear roller 52. Then, the thin section S carried to the liquid bath 8 together with the endless belt 53 leaves the endless belt 53 at the time at which the thin section S is brought into contact with the liquid W stored in the liquid bath 8. Thus, the thin section S is floated and extended on the fluid W. After that, the thin section is passed to the subsequent process step.

The setting step S1 to the carrying step S4 are in turn repeated to continuously prepare a plurality of thin sections S from the embedded block B.

As discussed above, in accordance with the thin section preparing apparatus 1 and the thin section preparing method according to the embodiment, the sliding direction Y in relatively sliding the embedded block B and the cutter 3 is simply set in the direction nearly orthogonal to the approaching and separating direction X, regardless of the slope of the nose 3b of the cutter 3. Therefore, even though the cutter 3 is attached with inclination to the horizontal plane, such complicated control before is eliminated that the slope of the nose 3b of the cutter 3 is detected and the cutter 3 is moved along the detected slope. Accordingly, the configuration can be simplified, and costs can be reduced.

In addition, the control unit 4 controls the motions of the cutter 3 and the embedded block B from the initial positions in conducting the cutting step S3 in such a way that the embedded block B is brought into contact at the same point of the nose 3b of the cutter 3, and then the cutter 3 is slid in the same direction as the ratio between the velocity in the approaching and separating direction X and the velocity in the sliding direction Y is maintained uniformly. On this account, even though many thin sections S are sliced off from the embedded block B, only the same area of the nose 3b of the cutter 3 can be continuously used. In other words, it can be prevented that the embedded block B is sometimes sliced on the base end side of the nose 3b or sometimes on the tip end side of the nose 3b, and the embedded block B can be sliced in a determined area of the cutter 3 every time.

In addition, in the cutting step S3, in relatively moving the embedded block B and the cutter 3 along the approaching and separating direction X and the sliding direction Y, the control unit 4 controls the operations of the approach stage 6b and the slider unit 36 in such a way that the rate of travel in each of the directions becomes a constant speed. Thus, even in any directions, the operations of the approach stage 6b and the slider unit 36 are controlled so as to simply repeat a certain operation. Accordingly, control conducted by the control unit 4 in the cutting step S3 can be made easier, and the configuration can be more simplified.

Particularly, because the rates of travel in the two directions (the approaching and separating direction X and the sliding direction Y) are at a constant speed all the time, the same resultant force continuously acts on the thin section S to be sliced off. Thus, the similar effect can be obtained as the effect that the embedded block B is sliced as the same declination angle is provided all the time. Consequently, stable slicing can be conducted, and a thin section S of high quality can be prepared with no wrinkles.

In addition, in the height adjusting step S2, the sample stage 2 on which the embedded block B is fixed is simply moved along the ascending and descending guide rail 7a of the Z-stage 7, whereby the embedded block B and the cutter 3 can be relatively moved along the vertical direction Z. Similarly, in the cutting step S3, the sample stage 2 is moved along the approach guide rail 6a of the X-stage 6 and the holder 31 on which the cutter 3 is fixed is moved along the sliding direction Y, whereby the embedded block B and the cutter 3 can be relatively moved along the approaching and separating direction X and the sliding direction Y. Accordingly, such a complicated motion is eliminated that the embedded block B or the cutter 3 is moved in a different direction, and such a simple motion is enough that the embedded block B or the cutter 3 is simply moved in one direction. Thus, the motions of the ascending and descending stage 7b, the approach stage 6b, and the slider unit 36 can be made easier, and the configuration can be more simplified.

In addition, here, in preparing the thin section S, the rough sectioning operation is first conducted in which the embedded block B is roughly sectioned, and then the fine sectioning operation is conducted to prepare the thin section S. The advantages described above can be exerted in conducting each of the operations. Particularly, in the cutting step S3, the rough sectioning operation and the fine sectioning operation are conducted under the same velocity ratio condition, whereby the rough sectioning and fine sectioning operations can be conducted under the same slicing condition. In other words, in order to prepare a thin section S of higher quality, even though the rate of travel in the rough sectioning operation is set fast and the rate of travel in the fine sectioning operation is set slowly, control is conducted in such a way that the position of contacting the nose 3b of the cutter 3 with the embedded block B is made constant all the time and the ratio between the velocity in the approaching and separating direction X and the velocity in the sliding direction Y is maintained constantly. Thus, the cutting step S3 can be conducted under the same slicing condition.

Therefore, even though the nose 3b of the cutter 3 has waviness, the front surface B2 of the embedded block B is in the form following the waviness of the cutter 3. Thus, thin sections S can be sliced off in a uniform thickness. Accordingly, a thin section S of high quality can be prepared with no occurrence of dyeing speck even stained.

As discussed above, the embodiment of the invention has been described in detail with reference to the drawings. However, the specific configurations will not be limited to the embodiment above, and design modifications can be included within the scope not deviating from the teachings of the invention.

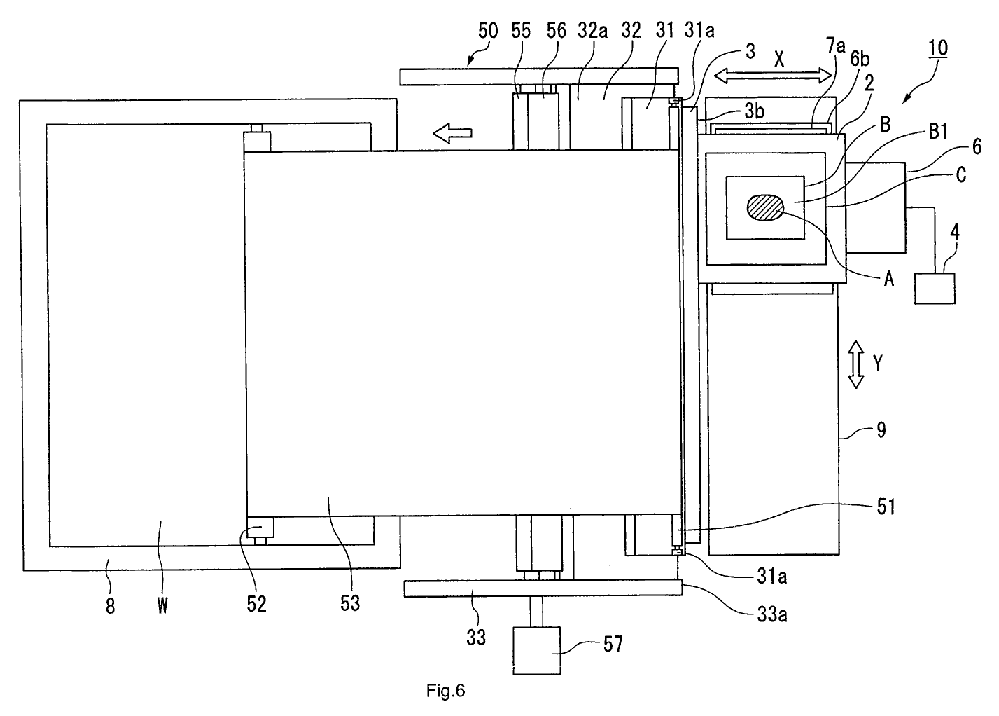

For example, in the embodiment, in order to relatively move the embedded block B and the cutter 3 along the approaching and separating direction X and the sliding direction Y, the embedded block B is moved along the approaching and separating direction X, and the cutter 3 is moved along the sliding direction Y. However, the invention is not limited thereto. For example, a thin section preparing apparatus 10 can exert the advantages similar to those of the embodiment, which has a Y-stage (sliding mechanism) 9 that moves a sample stage 2 along the sliding direction Y, as shown in FIG. 6, instead of the sliding mechanism 30 that moves the cutter 3 along the sliding direction Y. In addition, both of the embedded block B and the cutter 3 may be moved along the approaching and separating direction X and the sliding direction Y.

In addition, in the embodiment, in the cutting step S3, the sliding mechanism 30 is operated at the same time of starting the operation of the X-stage 6. However, the invention is not limited to this case. It is sufficient that control is conducted in such a way that in slicing off the thin section S from the embedded block B, the embedded block B is brought into contact at the same point of the nose 3b of the cutter 3 and then the cutter 3 is slid in the same direction. For example, such a method may be used that in the cutting step S3, a time period required by the X-stage 6 until the embedded block B is brought into contact with the cutter 3 from the initial position is stored in advance and after this time period passes from the start of the operation of the X-stage 6, the operation of the sliding mechanism 30 is started. In addition, such a method may be used that a detecting unit is provided at a contact point between the embedded block B and the cutter 3, which detects the thin section S being brought into contact with the cutter 3 and sends a signal, and the operation of the sliding mechanism 30 is started based on the signal sent from the detecting unit.

In addition, in the embodiment, in the cutting step S3, the control unit 4 controls the rates of travel of the embedded block B moved by the X-stage 6 and the cutter 3 moved by the sliding mechanism 30 to be a constant speed. However, the invention is not limited thereto.

In addition, in the embodiment, in the thin section preparing apparatus 1, the carrying step S4 is conducted by the carrying unit 50 using the endless belt 53 after the cutting step S3. However, the invention is not limited thereto. For example, a carrier tape may be used as the carrying unit. In this case, it is sufficient that electric charges having different polarities are charged to the embedded block B and the carrier tape, and the thin section S is attached to the carrier tape by static electricity for transport.

What is claimed is:

1. A thin section preparing apparatus that slices an embedded block having a biological sample embedded therein to prepare a thin section, the apparatus comprising:
a cutter that slices the embedded block;
a moving mechanism that relatively moves the embedded block and the cutter along an approaching and separating direction in parallel with an assumed plane, in the direction in which the embedded block and the cutter approach and separate from each other, and slices off the thin section from the embedded block by the cutter;
a height adjusting mechanism that relatively moves the embedded block and the cutter along a vertical direction vertical to the assumed plane and adjusts a height of the embedded block;
a sliding mechanism that relatively moves the embedded block and the cutter along a sliding direction in parallel with the assumed plane and nearly orthogonal to the approaching and separating direction, and relatively slides the embedded block and the cutter in slicing off the thin section; and
a control unit that controls operations of the moving mechanism and the sliding mechanism in slicing off the thin section in such a way that the embedded block and the cutter begin to move from an initial position set in advance, the embedded block is brought into contact at a same point of a nose of the cutter, and then the cutter is slid in the same direction as a ratio between a velocity in the approaching and separating direction and a velocity in the sliding direction is kept the same.

2. The thin section preparing apparatus according to claim 1,
wherein in relatively moving the embedded block and the cutter along the approaching and separating direction and the sliding direction, the control unit individually controls the moving mechanism and the sliding mechanism in such a way that a rate of travel at least in any one of the moving directions becomes a constant speed.

3. The thin section preparing apparatus according to claim 2,
wherein in relatively moving the embedded block and the cutter along the approaching and separating direction and the sliding direction, the control unit individually controls the moving mechanism and the sliding mechanism in such a way that a rate of travel in each of the directions becomes a constant speed.

4. The thin section preparing apparatus according to claim 1,
wherein the moving mechanism has an approach guide rail that extends along the approaching and separating direction, and an approach stage that is movable along the approach guide rail as the embedded block is held,
the height adjusting mechanism has an ascending and descending guide rail that is extended along the vertical direction, and an ascending and descending stage that is movable along the ascending and descending guide rail as the embedded block is held, and
the sliding mechanism has a cutter holder that holds the cutter, and a slider unit that moves the cutter holder along the sliding direction.

5. A thin section preparing method of slicing an embedded block having a biological sample embedded therein by a cutter to prepare a thin section, the method comprising the steps of:
setting wherein positions of the embedded block and the cutter are individually moved to initial positions set in advance;
adjusting height wherein the embedded block and the cutter are relatively moved along a vertical direction vertical to an assumed plane to adjust a height of the embedded block set at the initial position to be a predetermined height; and
cutting wherein after the height adjusting step, the embedded block and the cutter are relatively moved along two directions, an approaching and separating direction in parallel with the assumed plane, in the direction in which the embedded block and the cutter approach and separate from each other, and a sliding direction in parallel with the assumed plane and nearly orthogonal to the approaching and separating direction, and the embedded block is sliced to cut off the thin section while the embedded block and the cutter are being relatively slid,
wherein motions of the cutter and the embedded block are controlled from the initial positions in such a way that in conducting the cutting step, the embedded block is brought into contact at a same point of a nose of the cutter, and then the cutter is slid in the same direction as a ratio between a velocity in the approaching and separating direction and a velocity in the sliding direction is kept the same.

6. The thin section preparing method according to claim 5,
wherein in relatively moving the embedded block and the cutter along the approaching and separating direction and the sliding direction in the cutting step, control is conducted in such a way that a rate of travel at least in any one of the moving directions becomes a constant speed.

7. The thin section preparing method according to claim 6,
wherein in relatively moving the embedded block and the cutter along the approaching and separating direction and the sliding direction in the cutting step, control is conducted in such a way that a rate of travel in each of the directions becomes a constant speed.

8. The thin section preparing method according to claim 5,
wherein in conducting the height adjusting step, the embedded block is moved along the vertical direction, and
in conducting the cutting step, the embedded block is moved along the approaching and separating direction and the cutter is moved along the sliding direction.

9. The thin section preparing method according to claim 5,
wherein the cutting step is conducted under a same velocity ratio condition by a rough sectioning operation in which the embedded block is roughly sectioned, and by a fine sectioning operation in which the embedded block after roughly sectioned is finely sliced.
